(19) United States
(12) Patent Application Publication
(10) Pub. No.: US 2026/0370391 A1
(43) Pub. Date: Nov. 19, 2026

(54) DOWNLINK (DL) MONITORING HANDLING INVALID SUBFRAMES FOR HYBRID AUTOMATIC REPEAT REQUEST (HARQ) PROCESSES WITH DISABLED HARQ FEEDBACK FOR LONG TERM EVOLUTION MACHINE TYPE COMMUNICATION (LTE-MTC) IN NON-TERRESTRIAL NETWORK (NTN) SIGNALING

(71) Applicant: Telefonaktiebolaget LM Ericsson (publ), Stockholm (SE)

(72) Inventors: Gerardo Agni MEDINA ACOSTA, Märsta (SE); Ola LUNDQVIST, Karlstad (SE)

(21) Appl. No.: 19/136,556

(22) PCT Filed: Dec. 19, 2023
(86) PCT No.: PCT/SE2023/051280

§ 371 Date: Jun. 6, 2025

Related U.S. Application Data
(60) Provisional application No. 63/476,562, filed on Dec. 21, 2022.

(51) Int. Cl. H04L 1/1812; H04L 1/1829; H04W 4/70; H04W 72/232

(52) U.S. Cl. CPC H04L 1/1812; H04L 1/1854; H04W 4/70; H04W 72/232

(57) ABSTRACT

A method, network node and wireless device are disclosed. At least one embodiment includes a network node configured to transmit at least one or both of a Machine-Type Communications physical downlink control channel (MPDCCH) and a physical downlink shared channel (PDSCH) associated with a hybrid automatic repeat request (HARQ) process. The network node includes, when HARQ feedback for the HARQ process is disabled, refrain from transmitting or apply a scheduling restriction regarding transmitting the at least one or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by a wireless device (WD) is a bandwidth reduced low complexity coverage enhancement downlink (BL/CE DL), subframe.

### TECHNICAL FIELD

The present disclosure relates to wireless communications, and in particular, to designs for HARQ processes.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

During a Radio Access Network (RAN) plenary meeting, a new work item (WI) titled “New WID on IoT NTN enhancements” was considered. The work-item description (WID) includes, as an objective:

### Disabling of HARQ Feedback to Mitigate Impact of HARQ Stalling on UE Data Rates [RAN1,RAN2]

A reason for considering disabling the Hybrid Automatic Repeat Request (HARQ) feedback for Internet of things (IoT) non-terrestrial networks (NTN) is because of the large roundtrip delay between the wireless device (WD) and the network node (e.g., eNB). The following table shows both the delay and doppler shift values for various satellite orbits:

Delay and Doppler shift values for various satellite orbits.

| | LEO | | | | GEO | |
|---|---|---|---|---|---|---|
| Orbit altitude | 600 | km | 1200 | km | 35.786 | km |
| Distance at | 1932 | km | 3131 | km | 40.581 | km |
| minimum elevation | | | | | | |
| Delay at maximum | 8.0 | ms | 16.0 | ms | 477 | ms |
| elevation | | | | | | |
| Delay at minimum | 25.8 | ms | 41.8 | ms | 541 | ms |
| elevation | | | | | | |
| Maximum | 24 | ppm | 21 | ppm | <1 | ppm |
| Doppler shift | | | | | | |
| Maximum Doppler | 0.27 | ppm/s | 0.13 | ppm/s | ~0 | ppm/s |
| shift variation | | | | | | |

Although the large roundtrip delays between wireless device and network node can in principle suggest that in IoT NTN the HARQ feedback should be disabled, using existing functionalities embedded in the LTE-machine-type-communication (LTE-MTC) and narrow-band-IoT (NB-IoT) features make possible obtaining non-negligible data rates (i.e., in the order of hundreds of kbps) in some scenarios.

An objective by the 3GPP in Technical Release 18 (“3GPP Rel-18”) on “Disabling of HARQ feedback to mitigate impact of HARQ stalling on UE data rates” was kicked-off, and both enabling and disabling of HARQ feedback were considered.

### 3GPP Discussions

For IoT NTN, to configure or indicate enabling or disabling on HARQ feedback for downlink transmission, one or more of the following options can be considered:
Option 1: per HARQ process via wireless-device-specific radio resource control (RRC) signaling;
Option 2: per HARQ process via system-information-block (SIB) signaling;
Option 3: explicitly indicated by downlink control information (DCI) (e.g., new field or reusing existing field);
Option 4: implicitly determined by existing configured/indicated parameter(s) (e.g., repetition number, transport block size (TBS));
Option 5: per HARQ process via medium access control control element (MAC CE); and/or.
Other options or combinations are not excluded

Note: Option(s) for enhanced machine-type communication (eMTC) and NBIoT can be separately discussed. 3GPP Discussions

For IoT NTN, further study of the potential issues due to enabling/disabling on HARQ feedback for downlink transmission include:
Issue A: semi-persistent scheduling (SPS) physical downlink shared channel (PDSCH);
Issue B: (N) PDSCH/(N) physical downlink control channel (PDCCH) scheduling restriction;
Issue C: HARQ feedback for scheduling multiple transport block (TB);
Issue D: HARQ bundling for eMTC half-duplex frequency division duplex (HD-FDD);
Issue F: narrowband physical random-access channel (NPRACH) capacity;
Issue G: Serving cell/satellite change during data transfer (for further study: for eMTC and/or NB-IoT); and/or.
Other issues are not excluded

Note: The “Issues” in common for eMTC and NB-IoT can be separately discussed.

In another 3GPP RAN consideration, “to configure/indicate enabling/disabling on HARQ feedback for downlink transmission” further evolved as follows: 3GPP Discussions (LTE-MTC)

For eMTC NTN, to configure/indicate enabling/disabling of HARQ feedback for downlink transmission, down select one or more from the following options:
Option 1: per HARQ process via UE specific RRC signaling;
Option 3: explicitly indicated by DCI (e.g., new field or reusing existing field);
Option 4: implicitly indicated by existing/configured/indicated/combined parameter(s) in the DCI (e.g., repetition number, TBS); and/or
Option 6: combinations of some options above. 3GPP Discussions (NB-IoT)

For NB-IoT NTN, to configure/indicate enabling/disabling of HARQ feedback for downlink transmission, down select one or more from the following options:
Option 1: per HARQ process via wireless-device-specific RRC signaling;
Option 3: explicitly indicated by DCI (e.g., new field or reusing existing field);
Option 4: implicitly indicated by existing configured/indicated/combined parameter(s) in the DCI (e.g., repetition number, TBS); and/or
Option 6: combinations of some options above.

During RAN1 #110-bis, the down selection was updated as follows:

### Further 3GPP Discussion

For NB-IoT NTN, to configure/indicate enabling/disabling of HARQ feedback for downlink transmission, down select ONE from the following options at RAN1 #111:
Option 6a-1: Support RRC signaling configured between Option 1 and Option 3; and/or
Option 6a-4: Support Option 1 by default, and support Option 3 to override default configuration for corresponding transmission.

In RAN1 #111, a working assumption covering both LTE-MTC and NB-IoT was reached:

### Working Assumption

For NB-IoT NTN and eMTC NTN for coverage enhancement (CE) Mode B, to configure/indicate enabling/disabling of HARQ feedback for downlink transmission:
Support Option 1 by default, and support Option 3 to override default configuration for corresponding transmission;
Additional RRC signaling to enable Option 3;
If the bitmap for option 1 is not present and if option 3 is configured then the DCI directly indicates HARQ enable/disable. Option 3 can also be configured when the bitmap for option 1 is configured;
FFS #1: Option 3 DCI-based overridden mechanism is applied to both semi-statically HARQ enabled and disabled processes or only applied to semi-statically HARQ disabled processes or only applied to semi-statically HARQ enabled processes; and/or
FFS #2: whether/how to support Option 3 overriding default configuration for corresponding transmission for multiple TBs scheduled by single DCI.

For eMTC NTN, to configure/indicate enabling/disabling of HARQ feedback for downlink transmission, take Option 1 for CE Mode A.

Moreover, when the HARQ feedback is disabled, no uplink transmission occurs to acknowledge or not acknowledge (ACK/NACK) the received downlink data, and instead the wireless device will start a downlink (DL) monitoring. Thus one design aspect is the point in time at which the DL monitoring will be allowed to start receiving the subsequent scheduling of downlink data.

During RAN1 #110, an initial agreement touching upon this aspect was reached for NB-IoT: 3GPP Discussion

For a DL HARQ process with disabled HARQ feedback in NB-IoT, at least the following wireless device behavior(s) can be considered:
Option 1: wireless device is not expected to receive another NPDCCH carrying a DCI scheduling a NPDSCH for a given HARQ process that starts until X(ms) after the end of the reception of the last NPDSCH for that HARQ process;
X=12;
Option 2: wireless device is not required to monitor NPDCCH in a period of Y(ms) from the end of reception of the last NPDSCH; and/or
Y=12.

Note: there may be different wireless device behaviors for different wireless device categories (e.g., wireless device with single/multiple HARQ processes)/

During RAN1 #110, the value of “12 ms” was settled but the down-selection between “Option1” and “Option 2” remained under consideration.

Thereafter, in RAN1 #110-bis-e the agreement for NB-IoT further evolved as follows:

### 3GPP Discussions

For a DL HARQ process with disabled HARQ feedback in NB-IoT, wireless device is not required to monitor NPDCCH in a period of Y=12 (ms) from the end of reception of the NPDSCH.

On the other hand, for LTE-MTC nothing has been agreed yet on the same matter.

During a recent 3GPP meeting no agreement was reached but the following proposal was considered:

[Proposal 3-2a]:

For a DL HARQ process with disabled HARQ feedback in eMTC, the wireless device is not expected to receive another MTC physical downlink control channel (MPDCCH) carrying a DCI scheduling a PDSCH for a given HARQ process or to receive another PDSCH without corresponding MPDCCH for the given HARQ process that starts until X=3 (ms) after the end of the reception of the last PDSCH for that HARQ process.

### SUMMARY

Some embodiments advantageously provide methods, systems, and apparatuses for designs for HARQ processes.

The present disclosure relates to DL monitoring accounting for a future-proof design for HARQ processes with disabled HARQ feedback for LTE-MTC in NTN.

The present disclosure also relates to the “scheduling restriction” for LTE-MTC over NTN providing a revision on the description in the “time-domain” associated to the variable “X.”

In some embodiments, the following behavior is used as a baseline: For a DL HARQ process with disabled HARQ feedback in eMTC, wireless device is not expected to receive another MPDCCH carrying a DCI scheduling a PDSCH for a given HARQ process or to receive another PDSCH without corresponding MPDCCH for the given HARQ process that starts until X=3 (ms) after the end of the reception of the last PDSCH for that HARQ process.

In some embodiments, the terminology in the “scheduling restriction” for LTE-MTC is revised to account for both a future-proof solution handling the presence of invalid subframes (non-BL/CE DL subframes) and a hybrid scenario where at least one among all HARQ processes has its HARQ feedback enabled.

In some embodiments, the “time units” associated to the variable “X” can be revised as to also be expressed in terms of “BL/CE DL subframes.” That is, “X=A (ms)” can be revised as “X=A BL/CE DL subframes” in case it is beneficial to effectively count the no-monitored based on valid DL subframes (i.e., BL/CE DL subframes) when handling the presence of invalid subframes (i.e., non-BL/CE DL subframes). “A” can be any integer, for example A=3. Optionally, both descriptions (in terms of “ms” and in terms of “BL/CE DL subframes”) can be made available based on a configuration (e.g., semi-static RRC configuration).

The invalid subframes (non-BL/CE DL subframes) are subframes that won't be used to schedule MPDCCH nor PDSCH, since those subframe will be used for other purposes (e.g., long-term those subframes may be used to transmit positioning reference signals (PRS) or for dynamic spectrum sharing (DSS) or any other future feature/service).

Some embodiments may have one or more of the following advantages:
Incorporating the terminology “BL/CE DL subframes” into the “scheduling restriction” will allow handling scenarios beyond assuming all HARQ process have their HARQ feedback disabled;
A future-proof method is incorporated to the “scheduling restriction” for HARQ processes with disabled HARQ feedback, which will allow handling the presence of invalid subframes (non-BL/CE DL subframes);
The methods can be used when all HARQ process have their HARQ feedback disabled, or in hybrid enabling/disabling scenario (i.e., when at least one of the HARQ processes among all the HARQ processes has its HARQ feedback enabled);
The methods are agnostic to the number of HARQ processes configured, which can be 8, 10, or 14 HARQ processes;
The methods are agnostic to the satellite's type and orbit altitudes and/or.
The method may allow the wireless device to save battery through a proper counting of the subframe types not intended to be monitored. This avoids a premature monitoring starting from a subframe where downlink information cannot be received if such a subframe is an invalid subframe (no-BL/CE subframe).

According to one aspect, a method in a wireless device, WD, configured to communicate with a network node is provided. The method includes receiving at least one or both of a Machine-Type Communications physical downlink control channel, MPDCCH, and a physical downlink shared channel, PDSCH, associated with a hybrid automatic repeat request, HARQ, process. The method includes, when HARQ feedback for the HARQ process is disabled, waiting until a predetermined period after a last PDSCH reception to receive another MPDCCH or PDSCH, the predetermined period being a number of milliseconds and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe.

According to this aspect, in some embodiments, the predetermined period is a number of BL/CE DL subframes, the number of BL/CE DL subframes being an integer greater than two-. In some embodiments, when the HARQ feedback for the HARQ process is disabled, waiting until a predetermined period after a last PDSCH reception to receive another MPDCCH or PDSCH, the predetermined period being a number of BL/CE DL subframes and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe. In some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD are BL/CE DL subframes.

According to another aspect, a wireless device (WD) configured to communicate with a network node is provided. The WD is configured to: receive at least one or both of a Machine-Type Communications physical downlink control channel, MPDCCH, and a physical downlink shared channel, PDSCH, associated with a hybrid automatic repeat request, HARQ, process; and when HARQ feedback for the HARQ process is disabled, wait until a predetermined period after a last PDSCH reception to receive another MPDCCH or PDSCH, the predetermined period being a number of milliseconds and where, after the predetermined period has elapsed, a first or earliest subframe for which another MPDCCH or PDSCH for the HARQ process can be received by the WD is a bandwidth reduced low complexity coverage enhanced downlink, BL/CE DL, subframe.

According to this aspect, in some embodiments, the predetermined period is a number of BL/CE DL subframes, the number of BL/CE DL subframes being an integer greater than two. In some embodiments, when the HARQ feedback for the HARQ process is disabled, waiting until a predetermined period after a last PDSCH reception to receive another MPDCCH or PDSCH, the predetermined period being a number of BL/CE DL subframes and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe. In some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD are BL/CE DL subframes.

According to yet another aspect, a method in a network node configured to communicate with a wireless device is provided. The method includes transmitting at least one or both of a Machine-Type Communications physical downlink control channel, MPDCCH, and a physical downlink shared channel, PDSCH, associated with a hybrid automatic repeat request, HARQ, process. The method also includes, when HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

According to this aspect, in some embodiments, the predetermined period is a number of BL/CE DL subframes, the number of BL/CE DL subframes being an integer greater than two. In some embodiments, when the HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of BL/CE DL subframes and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe. In some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD are BL/CE DL subframes. In some embodiments, a number of subframes preceding the BL/CE DL subframe being the first or earliest subframe for which another MPDCCH or PDSCH for the HARQ process can be received by the WD are non-BL/CE DL subframes.

According to another aspect, a network node configured to communicate with a wireless device is provided. The network node is configured to: transmit at least one or both of a Machine-Type Communications physical downlink control channel, MPDCCH, and a physical downlink shared channel, PDSCH, associated with a hybrid automatic repeat request, HARQ, process; and when HARQ feedback for the HARQ process is disabled, refrain from transmitting or apply a scheduling restriction regarding transmitting the at least one or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

According to this aspect, in some embodiments, the predetermined period is a number of BL/CE DL subframes, the number of BL/CE DL subframes being an integer greater than two. In some embodiments, when the HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of BL/CE DL subframes and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

According to this aspect, in some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD are BL/CE DL subframes.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating example methods implemented in a communication system including a host computer, a network node and a wireless device for executing a client application at a wireless device according to some embodiments of the present disclosure;

FIG. 4 is a flowchart illustrating example methods implemented in a communication system including a host computer, a network node and a wireless device for receiving user data at a wireless device according to some embodiments of the present disclosure;

FIG. 5 is a flowchart illustrating example methods implemented in a communication system including a host computer, a network node and a wireless device for receiving user data from the wireless device at a host computer according to some embodiments of the present disclosure;

FIG. 6 is a flowchart illustrating example methods implemented in a communication system including a host computer, a network node and a wireless device for receiving user data at a host computer according to some embodiments of the present disclosure;

FIG. 7 is a flowchart of an example process in a network node according to some embodiments of the present disclosure;

FIG. 8 is a flowchart of an example process in a wireless device according to some embodiments of the present disclosure;

FIG. 9 is a flowchart of another example process in a network node according to some embodiments of the present disclosure;

FIG. 10 is a flowchart of another example process in a wireless device according to some embodiments of the present disclosure;

FIGS. 11A and 11B depict a table showing behavior of a scheduling restriction according to some embodiments of the present disclosure;

FIGS. 12A and 12B depict a table showing behavior of a scheduling restriction according to some embodiments of the present disclosure;

FIGS. 13A and 13B depict a table showing behavior of a scheduling restriction according to some embodiments of the present disclosure;

FIGS. 14A and 14B depict a table showing behavior of a scheduling restriction according to some embodiments of the present disclosure;

FIGS. 15A and 15B depict a table showing behavior of a scheduling restriction according to some embodiments of the present disclosure; and

FIGS. 16A and 16B depict a table showing behavior of a scheduling restriction according to some embodiments of the present disclosure.

### DETAILED DESCRIPTION

Before describing in detail example embodiments, it is noted that the embodiments reside primarily in combinations of apparatus components and processing steps related to designs for HARQ processes. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

It should be noted that in various embodiments the terms “non-BL/CE DL subframes” and “non-BL/CE UL subframes” in the 3GPP specifications were updated, meaning that these subframes are now known or described as “DL subframes that are not BL/CE DL subframes” and “UL subframes that are not BL/CE UL subframes.” Thus, through this disclosure, the terms “invalid DL subframes”, “non-BL/CE DL subframes, and subframes that are not BL/CE DL subframes” refer to the same thing and are interchangeable. Similarly, “invalid UL subframes,” “non-BL/CE UL subframes,” and “subframes that are not BL/CE UL subframes” refer to the same thing and are interchangeable. Moreover, in this disclosure the term cross-scheduling refers to the subframes encompassed from the subframe used for DL-to-UL switching till the subframe used for UL-to-DL switching.

In various embodiments, the term “Scheduling restriction” for HARQ Processes with Disabled HARQ feedback in LTE-MTC over NTN, accounts for scenarios beyond assuming all HARQ process have their HARQ feedback disabled, as well as a future-proof description that will be able to handle the presence of invalid subframes (i.e., non-BL/CE DL subframes). Thus, the terminology of the “scheduling restriction” for LTE-MTC includes the term “BL/CE DL subframe,” and alternatively the time during which the wireless device is not expected to receive an MPDCCH scheduling a PDSCH (or a PDSCH without an associated MPDCCH) for a given HARQ process is proposed to be expressed as X=“A” BL/CE DL subframes, where “A” can be any integer, for example A=3.

In some embodiments, PDSCH may comprise one or more subframes.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide designs for HARQ processes.

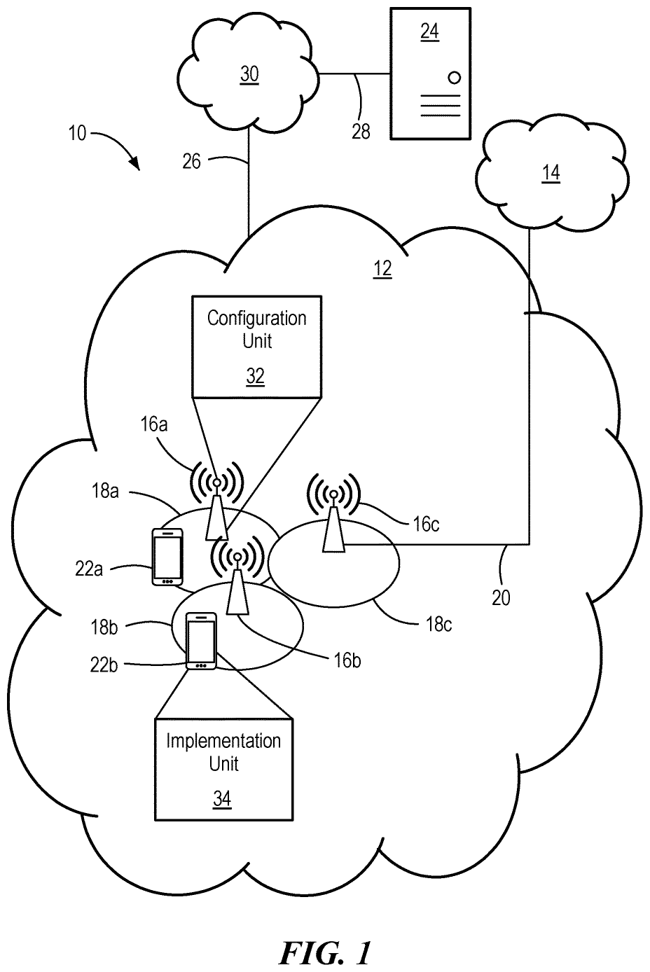

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including functions related to HARQ processes. A wireless device 22 is configured to include an implementation unit 34 which is configured to perform one or more wireless device 22 functions described herein, including functions related to HARQ processes.

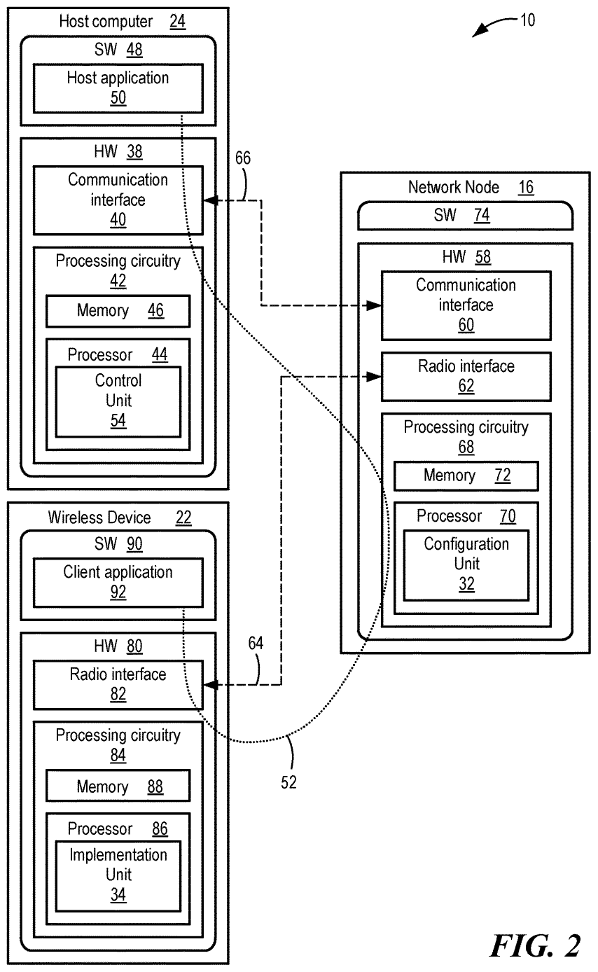

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 configured to perform one or more network node 16 functions described herein, including functions related to HARQ processes.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or more wireless device 22 functions described herein, including functions related to HARQ processes.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

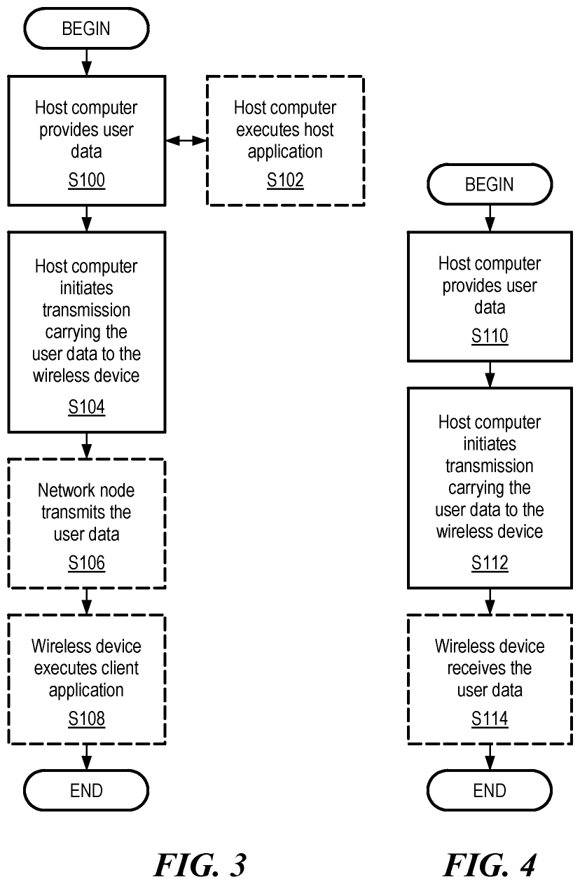

FIG. 3 is a flowchart illustrating an example method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

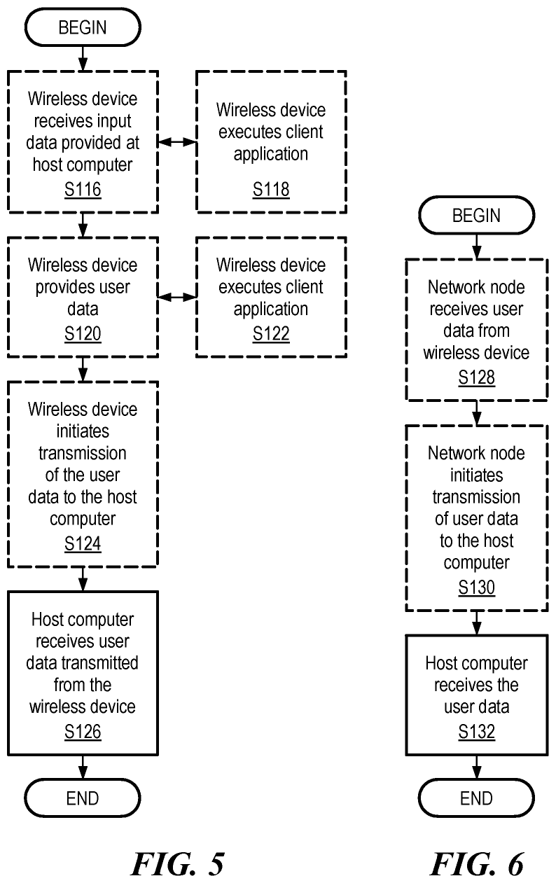

FIG. 5 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

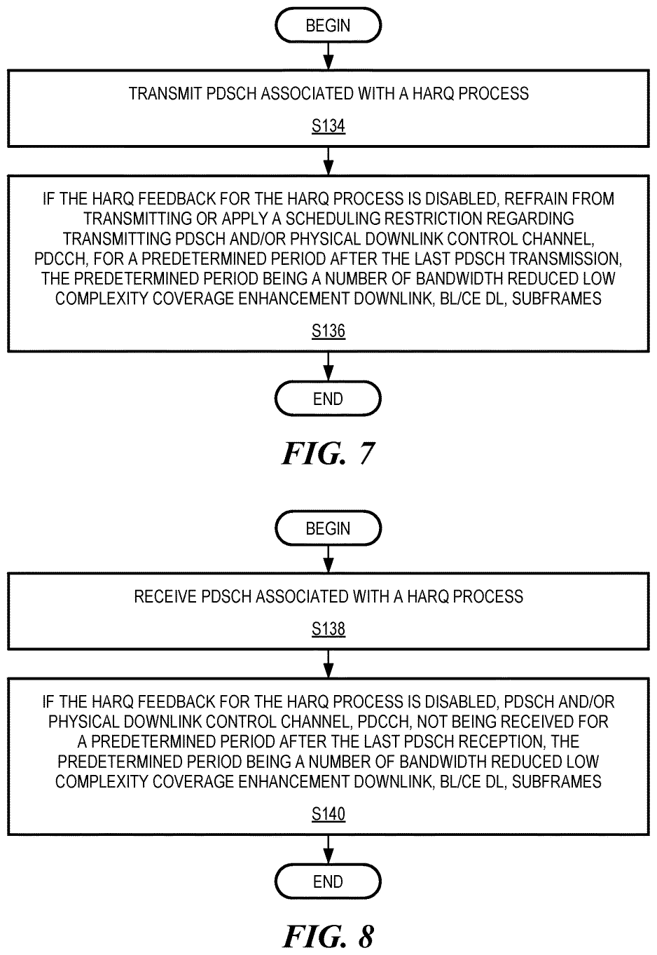

FIG. 7 is a flowchart of an example process in a network node 16. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to transmit PDSCH associated with a HARQ process (Block S134); and if the HARQ feedback for the HARQ process is disabled, refrain from transmitting or apply a scheduling restriction regarding transmitting PDSCH and/or physical downlink control channel, PDCCH, for a predetermined period after the last PDSCH transmission, the predetermined period being a number of Bandwidth Reduced Low Complexity Coverage Enhancement Downlink, BL/CE DL, subframes (Block S136). In some embodiments, the “predetermined period” may start after the end of the “last” PDSCH.

In one embodiment, the predetermined period is further based on a number of milliseconds.

In one embodiment, after the predetermined period has elapsed, the first or earliest subframe where another DL grant for that HARQ process can be received by the wireless device is a Bandwidth Reduced Low Complexity Coverage Enhancement Downlink, BL/CE DL, subframe.

In one embodiment, the network node 16 and/or the radio interface 62 and/or the processing circuitry 68 is further configured to transmit a downlink, DL, grant to the wireless device 22, the transmission including a Machine-Type-Communication Physical Downlink Control Channel, MPDCCH, which schedules the physical downlink shared channel, PDSCH, the DL grant having the associated hybrid automatic repeat request, HARQ, process.

In one embodiment, the associated HARQ process has been indicated using RRC signaling or is being indicated as part of the DL grant whether the HARQ feedback for that HARQ process is disabled or not.

In one embodiment the PDSCH is semi-persistently scheduled (SPS) by PDCCH. In this case, the SPS may be configured by RRC or a DCI.

FIG. 8 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive PDSCH associated with a HARQ process (Block S138). If the HARQ feedback for the HARQ process is disabled, PDSCH and/or physical downlink control channel, PDCCH, not being received for a predetermined period after the last PDSCH reception, the predetermined period being a number of Bandwidth Reduced Low Complexity Coverage Enhancement Downlink, BL/CE DL, subframes (Block S140).

In one embodiment, the predetermined period is further based on a number of milliseconds.

In one embodiment, after the predetermined period has elapsed, the first or earliest subframe where another DL grant for that HARQ process can be received by the wireless device is a Bandwidth Reduced Low Complexity Coverage Enhancement Downlink, BL/CE DL, subframe.

In one embodiment, the wireless device 22 and/or the radio interface 82 and/or the processing circuitry 84 is further configured to receive a downlink, DL, grant, the transmission including a Machine-Type-Communication Physical Downlink Control Channel, MPDCCH, which schedules the physical downlink shared channel, PDSCH, the DL grant having the associated hybrid automatic repeat request, HARQ, process.

In one embodiment, the associated HARQ process has been indicated using RRC signaling or is being indicated as part of the DL grant whether the HARQ feedback for that HARQ process is disabled or not.

In one embodiment, the PDSCH is semi-persistently scheduled by PDCCH. In this case, the SPS may be configured by RRC or a DCI.

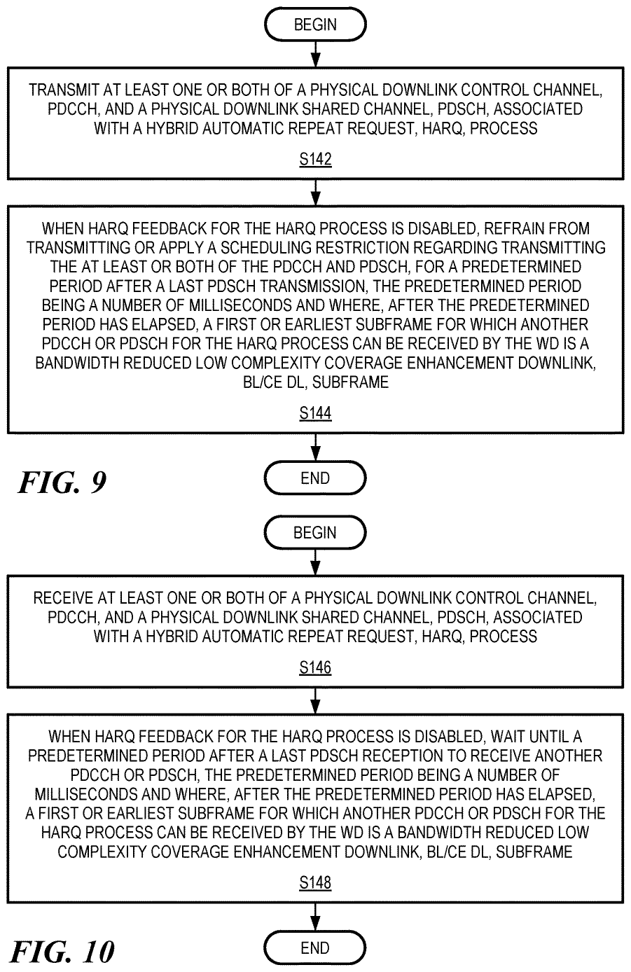

FIG. 9 is a flowchart of an example process in a network node 16. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to transmit at least one or both of a Machine-Type Communications physical downlink control channel, MPDCCH, and a physical downlink shared channel, PDSCH, associated with a hybrid automatic repeat request, HARQ, process (Block S142). The method also includes, when HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by the WD 22 is a bandwidth reduced low complexity coverage enhancement downlink, BL/CE DL, subframe (Block S144).

According to this aspect, in some embodiments, the predetermined period is a number of BL/CE DL subframes, the number of BL/CE DL subframes being an integer greater than two. In some embodiments, when the HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of BL/CE DL subframes and where, after the predetermined period has elapsed, a first or earliest subframe for which another MPDCCH or PDSCH for the HARQ process can be received by the WD 22 is a bandwidth reduced low complexity coverage enhancement downlink, BL/CE DL, subframe. In some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD 22 are BL/CE DL subframes. In some embodiments, a number of subframes preceding the BL/CE DL subframe being the first or earliest subframe for which another MPDCCH or PDSCH for the HARQ process can be received by the WD 22 are non-BL/CE DL subframes. FIG. 10 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive at least one or both of a Machine-Type Communications physical downlink control channel, MPDCCH, and a physical downlink shared channel, PDSCH, associated with a hybrid automatic repeat request, HARQ, process (Block S146). The method includes, when HARQ feedback for the HARQ process is disabled, waiting until a predetermined period after a last PDSCH reception to receive another MPDCCH or PDSCH, the predetermined period being a number of milliseconds and where, after the predetermined period has elapsed, a first or earliest subframe for which another MPDCCH or PDSCH for the HARQ process can be received by the WD 22 is a bandwidth reduced low complexity or coverage enhanced downlink, BL/CE DL, subframe (Block S148).

According to this aspect, in some embodiments, the predetermined period is a number of BL/CE DL subframes, the number of BL/CE DL subframes being an integer greater than 2. In some embodiments, when the HARQ feedback for the HARQ process is disabled, waiting until a predetermined period after a last PDSCH reception to receive another MPDCCH or PDSCH, the predetermined period being a number of BL/CE DL subframes and where, after the predetermined period has elapsed, a first or earliest subframe for which another MPDCCH or PDSCH for the HARQ process can be received by the WD 22 is a bandwidth reduced low complexity or coverage enhanced downlink, BL/CE DL, subframe. In some embodiments, when the HARQ feedback for the HARQ process is disabled, HARQ feedback for any other configured HARQ process is also disabled. In some embodiments, when the HARQ feedback for the HARQ process is disabled, HARQ feedback for at least one other HARQ process is enabled. In some embodiments, a number of subframes preceding the BL/CE DL subframe being the first or earliest subframe for which another MPDCCH or PDSCH for the HARQ process can be received by the WD 22 are BL/CE DL subframes.

Having described the general process flow of arrangements of the disclosure and having provided examples of hardware and software arrangements for implementing the processes and functions of the disclosure, the sections below provide details and examples of arrangements for HARQ process designs.

With regards to “scheduling restriction” for LTE-MTC, “For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts until X=3 (ms) after the end of the reception of the last PDSCH for that HARQ process.”

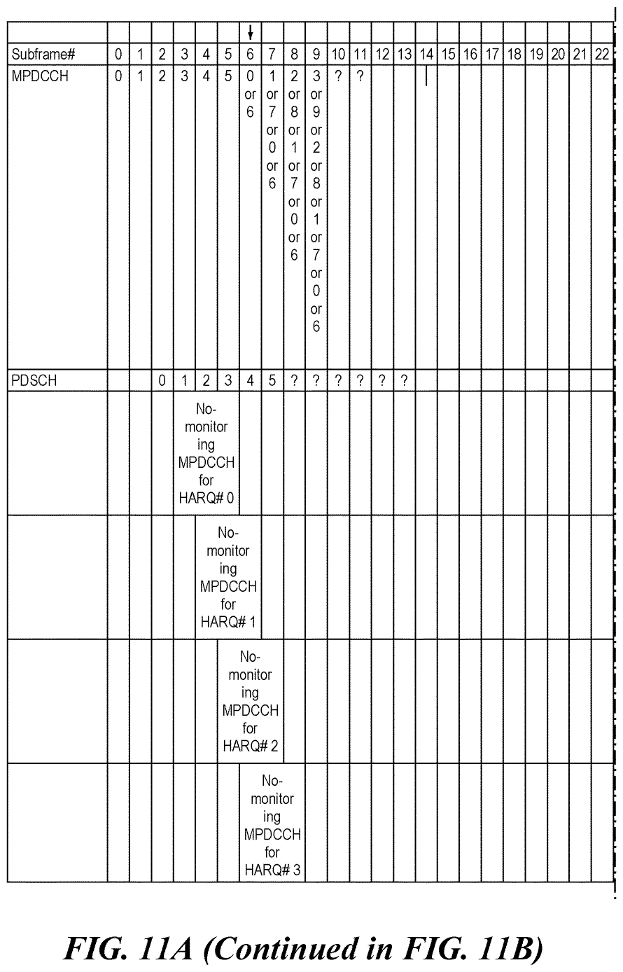

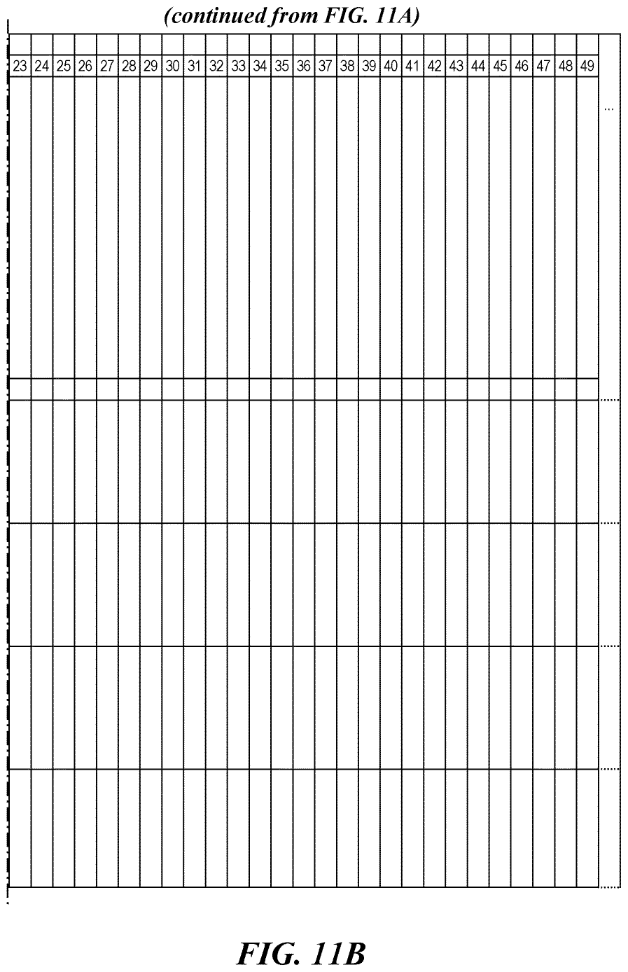

However, applying the above “scheduling restriction” proposal in a scenario with 10 HARQ processes all with HARQ feedback disabled is illustrated in FIGS. 11A and 11B, which is a table showing behavior of the “scheduling restriction” proposed in LTE-MTC for a scenario with 10 HARQ processes all with disabled HARQ feedback. The arrow pointing downwards “\” refers to the earliest subframe from which the subsequent MPDCCH for the HARQ process #0 can be received. Question marks “?” reflect that the HARQ processes to be respectively referred in the diagram depend on previous network decisions.

“HARQ process #0” shows that the very first transmission of MPDCCH #0 is at BL/CE DL subframe #0, whereas its associated PDSCH #0 is at BL/CE DL subframe #2. The proposed “scheduling restriction” states “For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts until X=3 (ms) after the end of the reception of the last PDSCH for that HARQ process”/Thus since PDSCH #0 ended also at BL/CE DL subframe #2, then during BL/CE DL subframes #3, #4, and #5 the wireless device 22 is not expected to receive MPDCCH scheduling PDSCH for HARQ process #0 This means that from BL/CE DL subframe #6 onwards, a subsequent MPDCCH scheduling PDSCH for HARQ process #0 can be received (see arrow pointing downwards in FIGS. 11A and 11B).

In the cases of the presence of invalid subframes (non-BL/CE DL subframes), which correspond to subframes that cannot be used to schedule MPDCCH or for transmitting PDSCH since those subframes will be used for other purposes (See “diagonal shadowed pattern” area representing the non-BL/CE DL subframes).

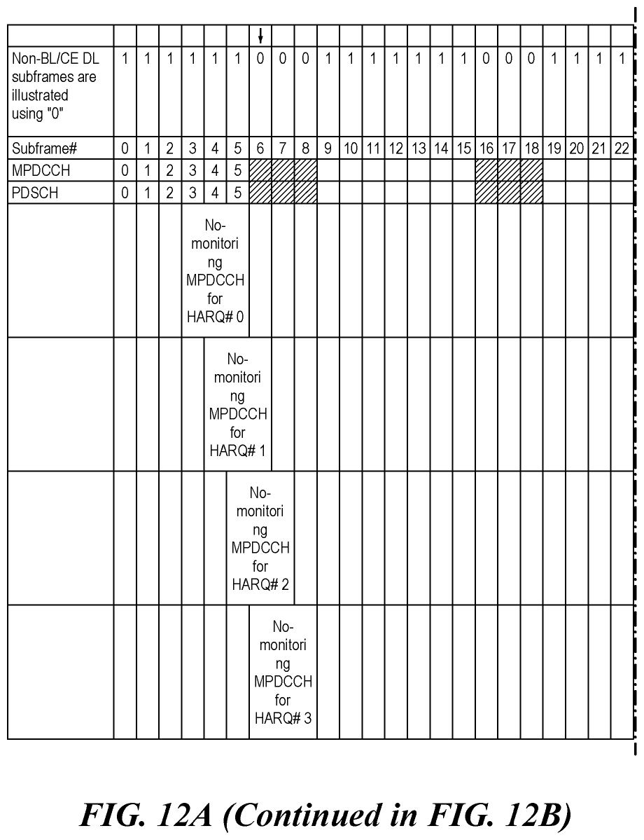

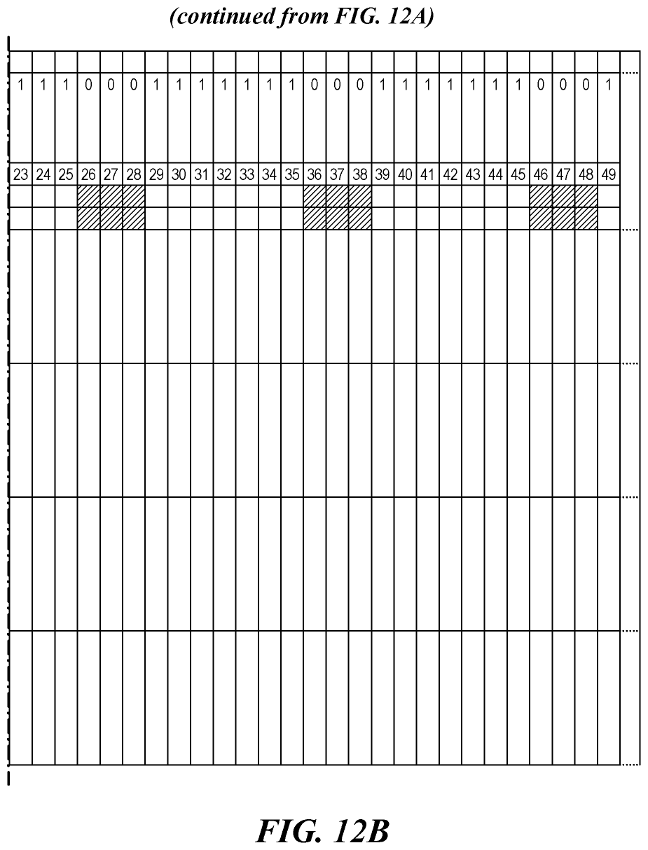

FIGS. 12A and 12B show an example table showing behavior of the “scheduling restriction” in presence of “invalid subframes (non-BL/CE DL subframes)” for a scenario with ten HARQ processes all with disabled HARQ feedback. The arrow pointing downwards is crossed-out “I” because the subsequent MPDCCH for the HARQ process #0 cannot be received (even though the milliseconds associated to no-monitoring have passed) due to the presence of an invalid subframe (non-BL/CE DL subframe).

With reference to “HARQ process #0,” as shown in FIGS. 12A and 12B, according to the “scheduling restriction”: “For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts until X=3 (ms) after the end of the reception of the last PDSCH for that HARQ process,” since PDSCH #0 ended at BL/CE DL subframe #2. Then, during BL/CE DL subframe #3, #4, and #5, the wireless device 22 is not expected to receive MPDCCH scheduling PDSCH for HARQ process #0, and in principle subframe #6 should be earliest subframe where MPDCCH for HARQ process #0 could be received. However, subframe #6 is an invalid subframe (non-BL/CE DL subframe), and no DL transmission may be performed at that point in time. Moreover, given that there are three invalid subframes (i.e., subframes 6, 7, and 8 are non-BL/CE DL subframes), then the earliest subframe at which MPDCCH for HARQ process #0 could be received is subframe #9 (i.e., a BL/CE DL subframe). In general, since the “scheduling restriction” states that the subsequent MPDCCH (or PDSCH without corresponding MPDCCH) starts until X=3 (ms) after the end of the reception of the last PDSCH for that HARQ process, then the no-monitoring behavior is not expected since even though the number of no-monitoring milliseconds (i.e., 3 ms) have passed and the receiver is expecting to receive an MPDCCH (or PDSCH) transmission, such a downlink transmission will not occur due to the presence of invalid subframes.

In some embodiments, to account for the potential presence of invalid subframes (non-BL/CE DL subframes), the “scheduling restriction” is defined in terms of “BL/CE DL subframes” for LTE-MTC over NTN.

In some embodiments, the following behaviors inherited from terrestrial networks also apply for LTE-MTC over NTN:
A downlink physical channel, e.g., MPDCCH and/or PDSCH cannot be transmitted on a BL/CE UL subframe. However, a downlink physical channel, e.g., MPDCCH and/or PDSCH can be transmitted on a non-BL/CE UL subframe since an invalid UL subframe doesn't make that subframe invalid for DL; and/or
Similarly, an uplink physical channel e.g., PUCCH may not be transmitted on a BL/CE DL subframe. However, an uplink physical channel, e.g., PUCCH, can be transmitted on a non-BL/CE DL subframe since an invalid DL subframe doesn't make that subframe invalid for UL.

In some embodiments, to account for the potential presence of uplink transmissions on BL/CE UL subframes for scenarios where at least one among all HARQ processes has its HARQ feedback enabled, the “scheduling restriction” for LTE-MTC over NTN is defined in terms of “BL/CE DL subframes” and combined with the legacy behaviors (inherited from terrestrial networks) in the clauses as shown in the below table depicting complementary legacy statements for the “scheduling restriction of NB-IoT” to handle more complex scenarios (i.e., “hybrid enabling/disabling HARQ feedback scenarios”);

| Complementary legacy statements for the | |
|---|---|
| “scheduling restriction of LTE-MTC” to | |
| handle “hybrid enabling/disabling HARQ | Clause and Technical |
| feedback scenarios” | Specification |
| 1) Avoidance of a Tx/Rx issue: half-duplex | Clause 4.1 of, e.g., |
| FDD operation for Frame structure type 1. | 3GPP TS 36.211 [9] |
| 2) Having time for re-tunning (e.g., | Clause 10.2.2.3 of, |
| UL-to-DL) when there is a PUCCH | e.g., 3GPP TS |
| transmission: “half-duplex guard subframe” | 36.211 [9] |
| for Type-B half-duplex FDD operation. | |

In some embodiments, defining the “scheduling restriction” for LTE-MTC over NTN in terms of “BL/CE DL subframes” aims at preparing this radio access technology (RAT) to co-exist with other services operating on the same spectrum over NTN. Those services can be, for example, dynamic spectrum sharing, positioning signals, etc., that exist in terrestrial networks and may be in the future adapted to NTN (or completely new NTN related services). Those services can be transmitted on the invalid subframes (non-BL/CE DL subframes).

In some embodiments, the “scheduling restriction” being used as baseline (or a similar one) is updated as follows to incorporate the term “BL/CE DL subframes”: For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts at a BL/CE DL subframe until X=3 (ms) have passed after the end of the reception of the last PDSCH for that HARQ process.

In some embodiments, the “scheduling restriction” being used as baseline (or a similar one) can be further revised as follows to also express the no-monitoring period in terms of BL/CE DL subframes: For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts at a BL/CE DL subframe until X=3 BL/CE DL subframes have passed after the end of the reception of the last PDSCH for that HARQ process

In some embodiments, the time during which the wireless device 22 is not expected to receive an MPDCCH scheduling a PDSCH (or a PDSCH without an associated MPDCCH) for a given HARQ process is proposed to be expressed as X= “A” BL/CE DL subframes, where “A” can be any integer, for example A=3.

In some embodiments, the time during which the wireless device 22 is not expected to receive an MPDCCH scheduling a PDSCH (or a PDSCH without an associated MPDCCH) for a given HARQ process can be defined in terms of both “milli seconds” (or absolute subframes) and in terms of “BL/CE DL subframes.” Which of the two definitions is to be used can be configurable using RRC signaling.

In some embodiments, the “scheduling restriction” defined in terms of “BL/CE DL subframes” applies regardless of the number of HARQ processes configured, which can be 8 HARQ processes, 10 HARQ processes, or 14 HARQ processes, for example.

In some embodiments, the “scheduling restriction” defined in terms of “BL/CE DL subframes” is agnostic to the satellite's type and orbit altitudes.

In some embodiments, the “scheduling restriction” defined in terms of “BL/CE DL subframes” is agnostic to the satellite's architecture (e.g., transparent payload or regenerative payload).

As an example in accordance with one or more embodiments: “scheduling restriction” is defined in terms of “BL/CE DL subframes” preserving X=3 ms, when there are 10 HARQ processes in use and three invalid subframes. All HARQ processes are assumed to have their HARQ feedback disabled.

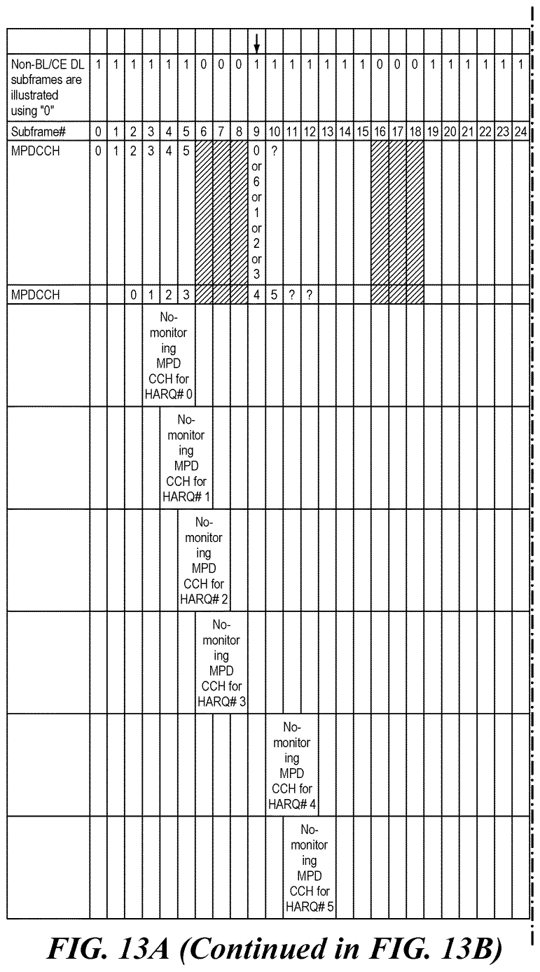

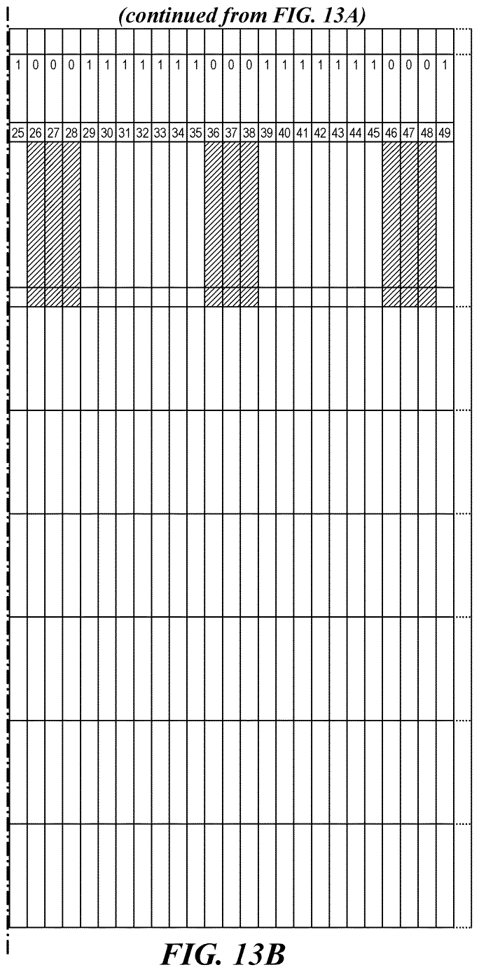

Using the revised “scheduling restriction” including the term “BL/CE DL subframe” and keeping X=3 ms, the resulting behavior is depicted in FIGS. 13A and 13B, FIGS. 13A and 13B show behavior of the “scheduling restriction” defined in terms of “BL/CE DL subframes” keeping X=3 ms, in the presence of “invalid subframes (non-BL/CE DL subframes)” for a scenario with ten HARQ processes all with disabled HARQ feedback. The arrow pointing downwards “I” refers to the earliest BL/CE DL subframe from which the subsequent MPDCCH for the HARQ process #0 can be received. Overall, the question marks “?” are intended to reflect that the HARQ processes to be respectively referred in the diagram depend on previous network decisions.

Focusing on “HARQ process #0,” but now using a revised “scheduling restriction” accounting for the presence of invalid subframes (non-BL/CE DL subframes): “For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts at a BL/CE DL subframe until X=3 (ms) have passed after the end of the reception of the last PDSCH for that HARQ process,” since PDSCH #0 ended at BL/CE DL subframe #2. Then during 3 ms (regardless of whether the encompassed subframes are valid or invalid subframes) the wireless device 22 is not expected to receive MPDCCH scheduling PDSCH for HARQ process #0 in BL/CE DL subframes #3, #4, and #5/Thereafter, non-BL/CE DL subframes #6, #7, and #8 are skipped or not counted since MPDCCH for HARQ process #0 can earliest be received at subframe #9, which is yet again a valid subframe (i.e., BL/CE DL subframes) This comes from the added terminology “that starts at a BL/CE DL subframe until X=3 (ms) have passed after the end of the reception of the last PDSCH for that HARQ process.”

Now consider HARQ process #1, which initially transmits MPDCCH at BL/CE DL subframe #1 and its corresponding PDSCH at BL/CE DL subframe #3. Then, during 3 ms (regardless of whether the encompassed subframes are valid or invalid subframes), the wireless device 22 is not expected to receive MPDCCH scheduling PDSCH for HARQ process #1 in BL/CE DL subframes #4, #5, and non-BL/CE DL subframe #6. Thereafter, non-BL/CE DL subframes #7, and #8 are skipped or not counted since MPDCCH for HARQ process #1 can earliest be received at subframe #9, which is yet again a valid subframe (i.e., BL/CE DL subframes). This comes from the added terminology “that starts at a BL/CE DL subframe until X=3 (ms) have passed after the end of the reception of the last PDSCH for that HARQ process”.

It is worth noting that the network node 16 may have the freedom to prioritize transmitting at BL/CE DL subframe #9 either MPDCCH for HARQ process #0, #1 as described earlier, or MPDCCH for any other HARQ process that has already fulfilled the no-monitoring condition during 3 ms (e.g., HARQ processes #2 and #3, see FIGS. 13A and 13B), or MPDCCH for any other HARQ process that has not been transmitted for very first time yet (e.g., HARQ process #6).

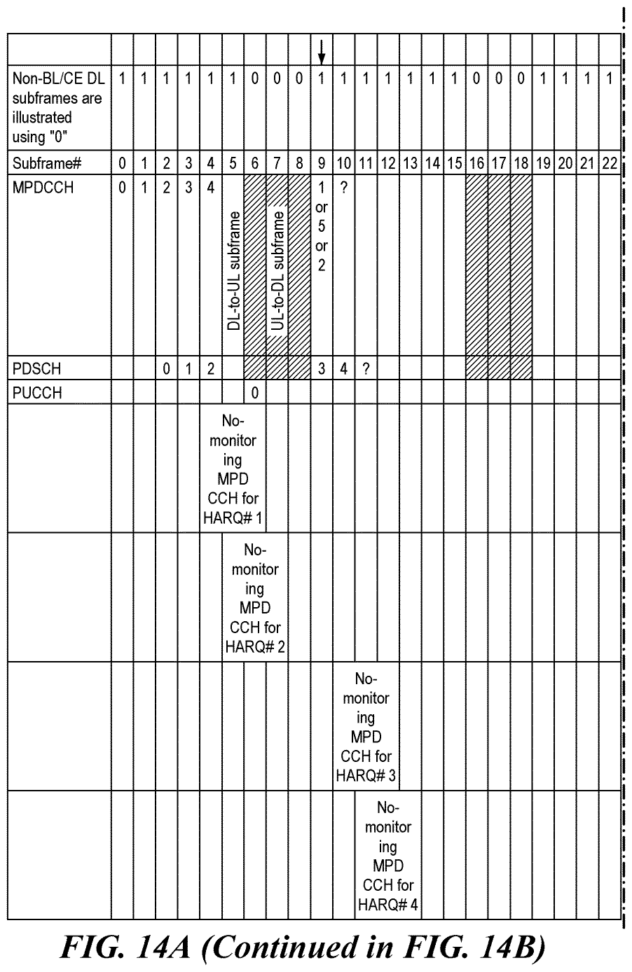

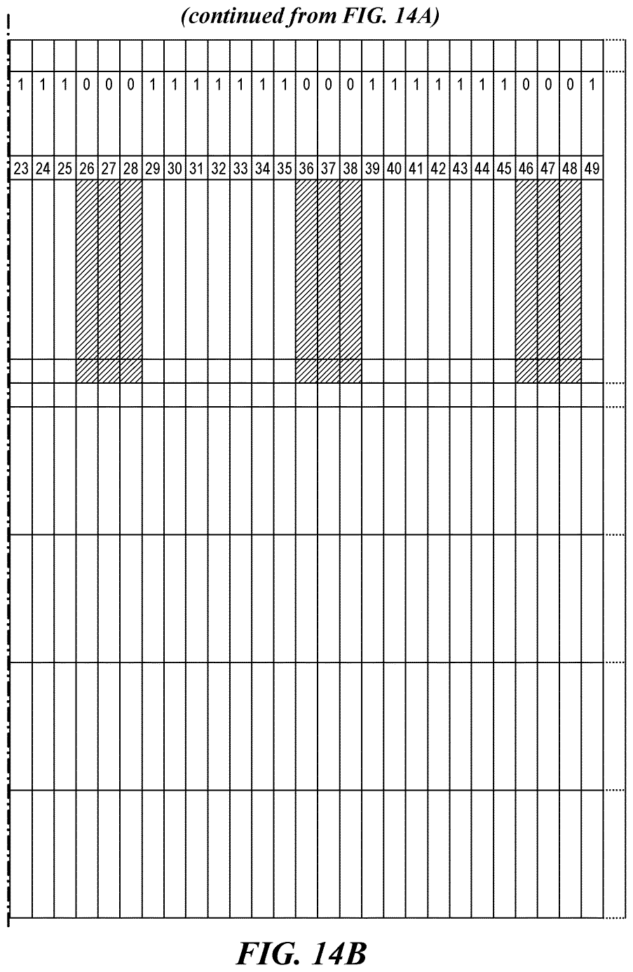

In some embodiments: “scheduling restriction” defined in terms of “BL/CE DL subframes” preserving X=3 ms, when there are 10 HARQ processes in use and three invalid subframes. HARQ processes #0 has it HARQ feedback enabled, and all other HARQ processes have their HARQ feedback disabled. FIGS. 14A and 14B show a chart showing behavior of the “scheduling restriction” defined in terms of “BL/CE DL subframes” preserving X=3 ms, in the presence of “invalid subframes (non-BL/CE DL subframes)” for a scenario with ten HARQ processes, all but one with disabled HARQ feedback. HARQ process #0 is assumed to have its HARQ feedback enabled (hence there is a PUCCH transmission in UL associated with it), and other HARQ processes have their HARQ feedback disabled. The arrow pointing downwards “\” refers to the earliest subframe from which the subsequent MPDCCH for the HARQ process #1 can be received. Recall HARQ process #0 had its HARQ feedback enabled, so it transmitted an ACK/NACK using PUCCH. Overall, the question marks “?” are intended to reflect that the HARQ processes shown in the diagram depend on previous network decisions.

In FIGS. 14A and 14B, HARQ process #0 has its “HARQ feedback enabled,” which means the received PDSCH in BL/CE DL subframe #2 is ACK/NACK using an uplink transmission over PUCCH in BL/CE UL subframe #6. It is worth noting that an invalid DL subframe (non-BL/CE DL subframe) does not make that subframe invalid for UL, hence PUCCH can be transmitted at BL/CE UL subframe #6.

Moreover, the subframe preceding the uplink transmission i.e., subframe #5 may be used as an absolute subframe to switch from DL-to-UL, whereas the subframe succeeding the uplink transmission i.e., subframe #7 may be used as an absolute subframe to switch from UL-to-DL.
Note A: An “absolute subframe” is a generic subframe used for the wireless device 22 to perform a “DL-to-DL switching” (i.e., to pass from receiving to transmitting), or to perform an “UL-to-DL switching” (i.e., to pass from transmitting to receiving). Absolute subframes can be seen as that they override BL/CE UL subframes and BL/CE DL subframe, and yet the “DL-to-UL switching” or “UL-to-DL switching” may occur respectively and as applicable on top of a non-BL/CE UL subframe or on top of a non-BL/CE DL subframe;
Note B: At the absolute subframes in FIGS. 14A and 14B, the wireless device 22 is expected to re-use/apply the behavior summarized in FIGS. 12A and 12B inherited from terrestrial networks related with a “half-duplex guard subframe” for Type-B half-duplex FDD operation in “Clause 10.2.2.3 of TS 36.211”; and/or
Note C: At the BL/CE UL subframe where PUCCH is transmitted as depicted in FIGS. 14A and 14B, the wireless device 22 is expected to re-use/apply the behavior summarized in FIGS. 12A and 12B inherited from terrestrial networks related with half-duplex FDD operation for Frame structure type 1 in “Clause 4.1 of TS 36.211”.

Then, HARQ process #1 is the first one with “HARQ feedback disabled” for which the “scheduling restriction” applies. On this matter, since PDSCH #1 ended at BL/CE DL subframe #3, then during 3 ms (regardless of whether the encompassed subframes are valid or invalid subframes in UL or DL, or absolute subframes), the wireless device 22 is not expected to receive MPDCCH scheduling PDSCH for HARQ process #1 in BL/CE DL subframe #4, absolute subframe #5, and BL/CE UL subframe #6. Thereafter, non-BL/CE DL subframes #7, and #8 are skipped or not counted since MPDCCH for HARQ process #1 can earliest be received at subframe #9, which is yet again a valid subframe (i.e., BL/CE DL subframes)> This comes from the added terminology “that starts at a BL/CE DL subframe until X=3 (ms) have passed after the end of the reception of the last PDSCH for that HARQ process.”

In some embodiments: “scheduling restriction” is defined in terms of “BL/CE DL subframes” further revising X=3 BL/CE DL subframes, when there are 10 HARQ processes in use and three invalid subframes. All HARQ processes may be assumed to have their HARQ feedback disabled.

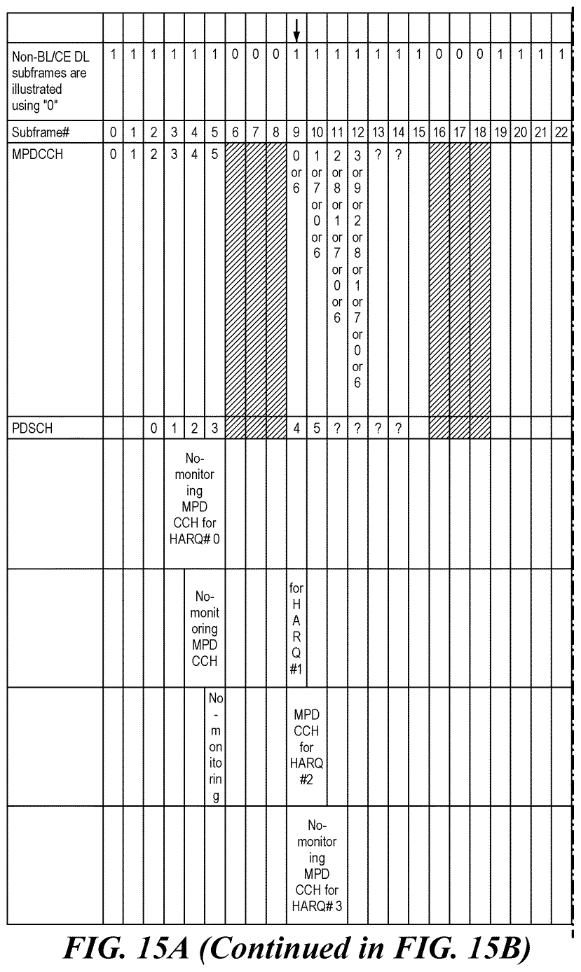

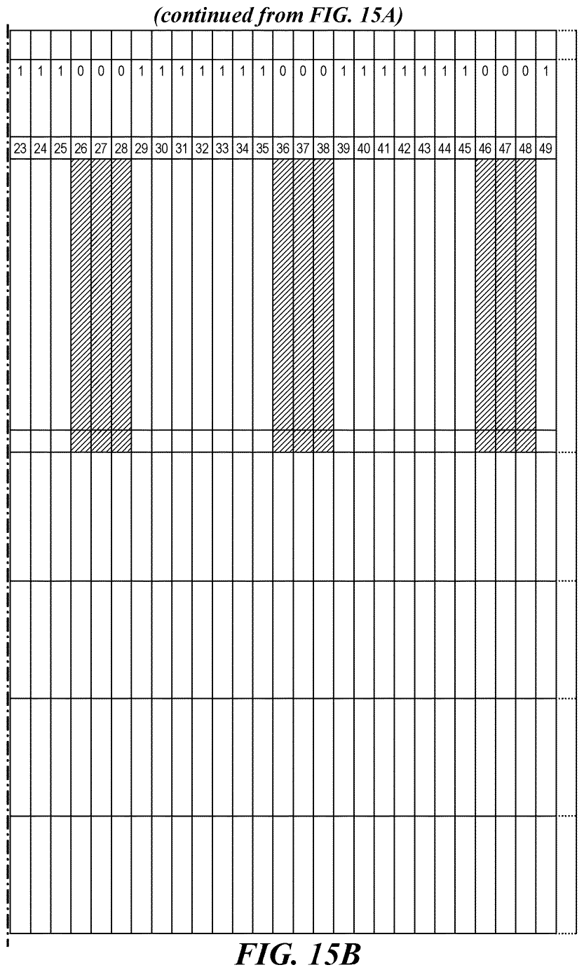

FIGS. 15A and 15B show behavior of the “scheduling restriction” defined in terms of “BL/CE DL subframes” and X=3 BL/CE DL subframes, in presence of “invalid subframes (non-BL/CE DL subframes)” for a scenario with ten HARQ processes all with disabled HARQ feedback. The arrow pointing downwards “⬇” refers to the earliest subframe from which the subsequent MPDCCH for the HARQ process #0 can be received. Overall, the question marks “?” are intended to reflect that the HARQ processes to be respectively referred in the diagram depend on previous network decisions.

Returning to the topic of “HARQ process #0”, but now using a further revised “scheduling restriction” including the “BL/CE DL subframes” terminology on the no-monitoring period X=3 BL/CE DL subframes: “For a DL HARQ process with disabled HARQ feedback in eMTC, wireless device 22 is not expected to receive another MPDCCH carrying a DCI scheduling a PDSCH for a given HARQ process or to receive another PDSCH without corresponding MPDCCH for the given HARQ process that starts at a BL/CE DL subframe until X=3 BL/CE DL subframes have passed after the end of the reception of the last PDSCH for that HARQ process.” Since PDSCH #0 ended at BL/CE DL subframe #2 then during subframe #3, subframe #4, and subframe #5 which are valid subframes (i.e., BL/CE DL subframes), the wireless device 22 is not expected to receive MPDCCH scheduling for HARQ process #0, then there are three invalid subframes (i.e., non-BL/CE DL subframes). Therefore subframes #6, #7, and #8 are skipped or not counted since MPDCCH for HARQ process #0 can earliest be received at subframe #9 which is yet again a valid subframe (i.e., BL/CE DL subframes).

Now consider HARQ process #1, which initially transmits MDPCCH at BL/CE DL subframe #1 and its corresponding PDSCH at BL/CE DL subframe #3, after which BL/CE DL subframes #4 and #5 count as the first 2 out of 3 BL/CE subframes that are not monitored for receiving a subsequent MPDCCH scheduling another PDSCH for HARQ process #1. Then subframes #6, #7, and #8 are not counted as the 3 out of 3 BL/CE subframes since those subframes are “non-BL/CE subframes”. Therefore BL/CE DL subframe #9 counts as the 3 out of 3 BL/CE subframes. This means that subframe #10 is the earliest BL/CE DL subframe from which the subsequent MPDCCH scheduling another PDSCH for HARQ process #1 can be received.

In some embodiments: “scheduling restriction” is defined in terms of “BL/CE DL subframes” further revising X=3 BL/CE DL subframes, when there are 10 HARQ processes in use and three invalid subframes. HARQ processes #0 has it HARQ feedback enabled, and all other HARQ processes have their HARQ feedback disabled.

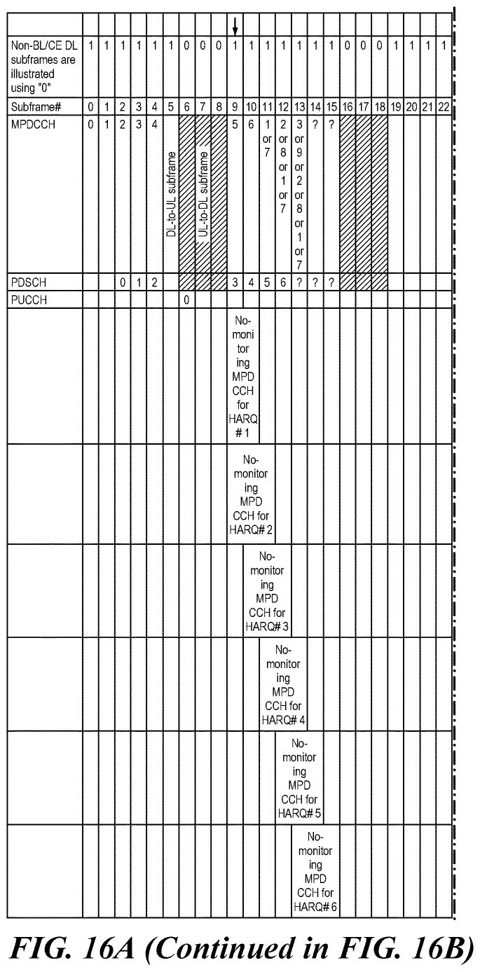

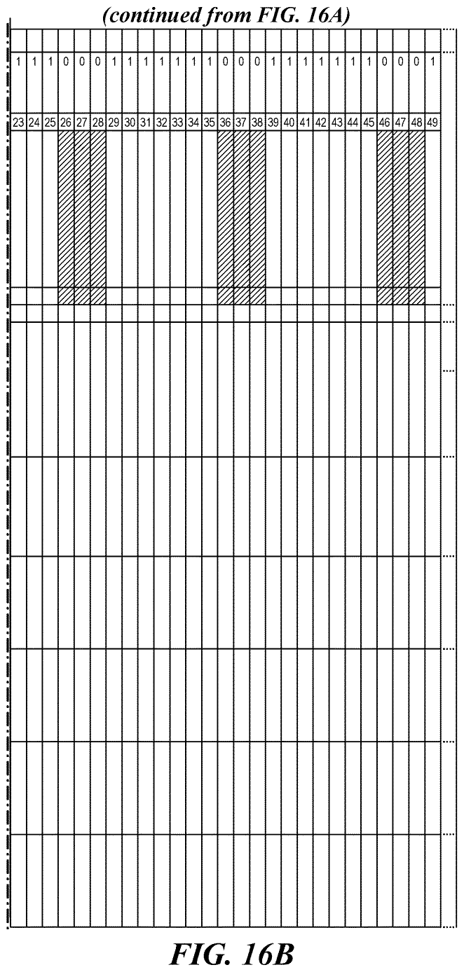

FIGS. 16A and 16B show a chart showing example behavior of the “scheduling restriction” defined in terms of “BL/CE DL subframes” and X=3 BL/CE DL subframes, in presence of “invalid subframes (non-BL/CE DL subframes)” for a scenario with ten HARQ processes all but one with disabled HARQ feedback. HARQ process #0 is assumed to have its HARQ feedback enabled (hence there is a PUCCH transmission in UL associated with it), and other HARQ processes have their HARQ feedback disabled. The arrow pointing downwards “⬇” refers to the earliest subframe from which the subsequent MPDCCH for the HARQ process #1 can be received. Recall HARQ process #0 had its HARQ feedback enabled, so it transmitted an ACK/NACK using PUCCH. Overall, the question marks “?” are intended to reflect that the HARQ processes to be respectively referred in the diagram depend on previous network decisions.

In FIGS. 16A and 16B, HARQ process #0 has its “HARQ feedback enabled”, which means the received PDSCH in BL/CE DL subframe #2 is ACK/NACK using an uplink transmission over PUCCH in BL/CE UL subframe #6. It is worth noting that an invalid DL subframe (non-BL/CE DL subframe) does not make that subframe invalid for UL. Hence PUCCH can be transmitted at BL/CE UL subframe #6. Moreover, the subframe preceding the uplink transmission i.e., subframe #5 (an absolute subframe) may be used to switch from DL-to-UL, whereas the subframe succeeding the uplink transmission i.e., subframe #7 (absolute subframe) may be used to switch from UL-to-DL.

Notes A, B, and C above also apply to this example.

Then, HARQ process #1 is the first one with “HARQ feedback disabled” for which the “scheduling restriction” applies. On this matter, since PDSCH #1 ended at BL/CE DL subframe #3, then towards the no-monitoring counting of X=3 BL/CE DL subframes, BL/CE DL subframe #4 counts as the 1st out of 3 BL/CE subframes. Then, subframe #5 is used for DL-to-UL switching, and after it there are three invalid subframes #6, #7, and #8 (i.e., non-BL/CE DL subframes) that are skipped or not counted. Thus, BL/CE DL subframe #9 and #10 are counted as the 2nd and 3rd out of 3 BL/CE subframes which means that subframe #11 is the earliest BL/CE DL subframe from which the subsequent MPDCCH scheduling another PDSCH for HARQ process #1 can be received.

Some embodiments may include one or more of the following:

Embodiment A1. A network node configured to communicate with a wireless device (WD), the network node configured to, and/or comprising a radio interface and/or comprising processing circuitry configured to:
transmit PDSCH associated with a HARQ process, and
if the HARQ feedback for the HARQ process is disabled, refrain from transmitting or apply a scheduling restriction regarding transmitting PDSCH and/or physical downlink control channel, PDCCH, for a predetermined period after the last PDSCH transmission, the predetermined period being a number of Bandwidth Reduced Low Complexity Coverage Enhancement Downlink, BL/CE DL, subframes.

Embodiment A2. The network node of Embodiment A1, wherein the predetermined period is further based on a number of milliseconds.

Embodiment A3. The network node of any of Embodiments A1 or A2, wherein after the predetermined period has elapsed, the first or earliest subframe where another DL grant for that HARQ process can be received by the wireless device is a Bandwidth Reduced Low Complexity Coverage Enhancement Downlink, BL/CE DL, subframe.

Embodiment A4. The network node of any of Embodiments A1-A3, wherein the network node and/or the radio interface and/or the processing circuitry is further configured to transmit a downlink, DL, grant to the wireless device, the transmission including a Machine-Type-Communication Physical Downlink Control Channel, MPDCCH, which schedules the physical downlink shared channel, PDSCH, the DL grant having the associated hybrid automatic repeat request, HARQ, process.

Embodiment A5. The network node of Embodiment A4, wherein the associated HARQ process has been indicated using RRC signaling or is being indicated as part of the DL grant whether the HARQ feedback for that HARQ process is disabled or not.

Embodiment A6. The network node of any of Embodiments A4 and A5, wherein the PDSCH is semi-persistently scheduled by PDCCH.

Embodiment B1. A method implemented in a network node, the method comprising:
transmitting PDSCH associated with a HARQ process, and
if the HARQ feedback for the HARQ process is disabled, refraining from transmitting or apply a scheduling restriction regarding transmitting PDSCH and/or physical downlink control channel, PDCCH, for a predetermined period after the last PDSCH transmission, the predetermined period being a number of Bandwidth Reduced Low Complexity Coverage Enhancement Downlink, BL/CE DL, subframes.

Embodiment B2. The method of Embodiment B1, wherein the predetermined period is further based on a number of milliseconds.

Embodiment B3. The method of any of Embodiments B1 or B2, wherein after the predetermined period has elapsed, the first or earliest subframe where another DL grant for that HARQ process can be received by the wireless device is a Bandwidth Reduced Low Complexity Coverage Enhancement Downlink, BL/CE DL, subframe.

Embodiment B4. The method of any of Embodiments B1-B3, further comprising transmitting a downlink, DL, grant to the wireless device, the transmission including a Machine-Type-Communication Physical Downlink Control Channel, MPDCCH, which schedules the physical downlink shared channel, PDSCH, the DL grant having the associated hybrid automatic repeat request, HARQ, process.

Embodiment B5. The method of Embodiment B4, wherein the associated HARQ process has been indicated using RRC signaling or is being indicated as part of the DL grant whether the HARQ feedback for that HARQ process is disabled or not.

Embodiment B6. The method of any of Embodiments B4 and B5, wherein the PDSCH is semi-persistently scheduled by PDCCH.

Embodiment C1. A wireless device (WD) configured to communicate with a network node, the WD configured to, and/or comprising a radio interface and/or processing circuitry configured to:
receive PDSCH associated with a HARQ process, and
if the HARQ feedback for the HARQ process is disabled, PDSCH and/or physical downlink control channel, PDCCH, not being received for a predetermined period after the last PDSCH reception, the predetermined period being a number of Bandwidth Reduced Low Complexity Coverage Enhancement Downlink, BL/CE DL, subframes.

Embodiment C2. The wireless device of Embodiment C1, wherein the predetermined period is further based on a number of milliseconds.

Embodiment C3. The wireless device of any of Embodiments C1 or C2, wherein after the predetermined period has elapsed, the first or earliest subframe where another DL grant for that HARQ process can be received by the wireless device is a Bandwidth Reduced Low Complexity Coverage Enhancement Downlink, BL/CE DL, subframe.

Embodiment C4. The wireless device of any of Embodiments C1-C3, wherein the wireless device and/or the radio interface and/or the processing circuitry is further configured to receive a downlink, DL, grant, the transmission including a Machine-Type-Communication Physical Downlink Control Channel, MPDCCH, which schedules the physical downlink shared channel, PDSCH, the DL grant having the associated hybrid automatic repeat request, HARQ, process.

Embodiment C5. The wireless device of Embodiment C4, wherein the associated HARQ process has been indicated using RRC signaling or is being indicated as part of the DL grant whether the HARQ feedback for that HARQ process is disabled or not.

Embodiment C6. The wireless device of any of Embodiments C4 and C5, wherein the PDSCH is semi-persistently scheduled by PDCCH.

Embodiment D1. A method implemented in a wireless device (WD), the method comprising:
receiving PDSCH associated with a HARQ process, and
if the HARQ feedback for the HARQ process is disabled, PDSCH and/or physical downlink control channel, PDCCH, not being received for a predetermined period after the last PDSCH reception, the predetermined period being a number of Bandwidth Reduced Low Complexity Coverage Enhancement Downlink, BL/CE DL, subframes.

Embodiment D2. The method of Embodiment D1, wherein the predetermined period is further based on a number of milliseconds.

Embodiment D3. The method of any of Embodiments D1 or D2, wherein after the predetermined period has elapsed, the first or earliest subframe where another DL grant for that HARQ process can be received by the wireless device is a Bandwidth Reduced Low Complexity Coverage Enhancement Downlink, BL/CE DL, subframe.

Embodiment D4. The method of any of Embodiments D1-D3, further comprising receiving a downlink, DL, grant, the transmission including a Machine-Type-Communication Physical Downlink Control Channel, MPDCCH, which schedules the physical downlink shared channel, PDSCH, the DL grant having the associated hybrid automatic repeat request, HARQ, process.

Embodiment D5. The method of Embodiment D4, wherein the associated HARQ process has been indicated using RRC signaling or is being indicated as part of the DL grant whether the HARQ feedback for that HARQ process is disabled or not.

Embodiment D6. The method of any of Embodiments D4 and D5, wherein the PDSCH is semi-persistently scheduled by PDCCH.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| ACK | Acknowledgement |
| BL/CE | Bandwidth-reduced Low-complexity or |
| | Coverage Enhanced BL/CE) |
| DCI | Downlink Control Information |
| DL | Downlink |
| GEO | Geosynchronous Orbit |
| HARQ | Hybrid Automatic Repeat Request |
| HD-FDD | Half Duplex-Frequency Division Duplex |
| LEO | Low Earth Orbit |
| LTE | Long-Term Evolution |
| MPDCCH | MTC Physical Downlink Control Channel |
| MTC | Machine Type Communication |
| NTN | Non-Terrestrial Networks |
| NACK | Non-Acknowledgement |
| NPDSCH | Narrowband Physical Downlink Shared Channel |
| NPUSCH | Narrowband Physical Uplink Shared Channel |
| PDSCH | Physical Downlink Shared Channel |
| PUCCH | Physical Uplink Control Channel |
| Rx | Reception |
| TBS | Transport Block Size |
| TN | Terrestrial Networks |
| Tx | Transmission |
| UL | Uplink |
| WI | Work Item |
| WID | Work Item Description |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a wireless device, WD, configured to communicate with a network node, the method comprising:
receiving at least one or both of a Machine-Type Communications physical downlink control channel, MPDCCH, and a physical downlink shared channel, PDSCH, associated with a hybrid automatic repeat request, HARQ, process; and
when HARQ feedback for the HARQ process is disabled, waiting until a predetermined period after a last PDSCH reception to receive another MPDCCH or PDSCH, the predetermined period being a number of milliseconds and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe.

2. The method of claim 1, wherein the predetermined period is a number of BL/CE DL subframes, the number of BL/CE DL subframes being an integer greater than two.

3. The method of claim 1, wherein, when the HARQ feedback for the HARQ process is disabled, waiting until a predetermined period after a last PDSCH reception to receive another MPDCCH or PDSCH, the predetermined period being a number of BL/CE DL subframes and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe.

4. The method of claim 1, wherein, when the HARQ feedback for the HARQ process is disabled, HARQ feedback for any other configured HARQ process is also disabled.

5. The method of claim 1, wherein, when the HARQ feedback for the HARQ process is disabled, HARQ feedback for at least one other HARQ process is enabled.

6. The method of claim 1, wherein a number of subframes preceding the BL/CE DL subframe being the first or earliest subframe for which another MPDCCH or PDSCH for the HARQ process can be received by the WD are BL/CE DL subframes.

7. A wireless device, WD, configured to communicate with a network node, the WD configured to:
receive at least one or both of a Machine-Type Communications physical downlink control channel, MPDCCH, and a physical downlink shared channel, PDSCH, associated with a hybrid automatic repeat request, HARQ, process; and
when HARQ feedback for the HARQ process is disabled, wait until a predetermined period after a last PDSCH reception to receive another MPDCCH or PDSCH, the predetermined period being a number of milliseconds and where, after the predetermined period has elapsed, a first or earliest subframe for which another MPDCCH or PDSCH for the HARQ process can be received by the WD is a bandwidth reduced low complexity coverage enhanced downlink, BL/CE DL, subframe.

8. The WD of claim 7, wherein the predetermined period is a number of BL/CE DL subframes, the number of BL/CE DL subframes being an integer greater than 2.

9. The WD of claim 7, wherein, when the HARQ feedback for the HARQ process is disabled, waiting until a predetermined period after a last PDSCH reception to receive another MPDCCH or PDSCH, the predetermined period being a number of BL/CE DL subframes and where, after the predetermined period has elapsed, a first or earliest subframe for which another MPDCCH or PDSCH for the HARQ process can be received by the WD is a bandwidth reduced low complexity or coverage enhanced downlink, BL/CE DL, subframe.

10. The WD of claim 7, wherein, when the HARQ feedback for the HARQ process is disabled, HARQ feedback for any other configured HARQ process is also disabled.

11. The WD of claim 7, wherein, when the HARQ feedback for the HARQ process is disabled, HARQ feedback for at least one other HARQ process is enabled.

12. The WD of claim 7, wherein a number of subframes preceding the BL/CE DL subframe being the first or earliest subframe for which another MPDCCH or PDSCH for the HARQ process can be received by the WD are BL/CE DL subframes.

13. A method in a network node configured to communicate with a wireless device, WD, the method comprising:
transmitting at least one or both of a Machine-Type Communications physical downlink control channel, MPDCCH, and a physical downlink shared channel, PDSCH, associated with a hybrid automatic repeat request, HARQ, process; and
when HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

14. The method of claim 13, wherein the predetermined period is a number of BL/CE DL subframes, the number of BL/CE DL subframes being an integer greater than two.

15. The method of claim 13, wherein, when the HARQ feedback for the HARQ process is disabled, refraining from transmitting or apply a scheduling restriction regarding transmitting the at least or both of the MPDCCH and PDSCH for a predetermined period after a last PDSCH transmission, the predetermined period being a number of BL/CE DL subframes and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

16. The method of claim 13, wherein, when the HARQ feedback for the HARQ process is disabled, HARQ feedback for any other configured HARQ process is also disabled.

17. The method of claim 13, wherein, when the HARQ feedback for the HARQ process is disabled, HARQ feedback for at least one other HARQ process is enabled.

18. The method of claim 13, wherein a number of subframes preceding the BL/CE DL subframe being the first or earliest subframe for which another MPDCCH or PDSCH for the HARQ process can be received by the WD are BL/CE DL subframes.

19. The method of claim 13, wherein a number of subframes preceding the BL/CE DL subframe being the first or earliest subframe for which another MPDCCH or PDSCH for the HARQ process can be received by the WD are non-BL/CE DL subframes.

20. A network node configured to communicate with a wireless device, WD, the network node configured to:
transmit at least one or both of a Machine-Type Communications physical downlink control channel, MPDCCH, and a physical downlink shared channel, PDSCH, associated with a hybrid automatic repeat request, HARQ, process; and
when HARQ feedback for the HARQ process is disabled, refrain from transmitting or apply a scheduling restriction regarding transmitting the at least one or both of the MPDCCH and PDSCH for a predetermined period after a last PDSCH transmission, the predetermined period being a number of milliseconds and where, after the predetermined period has elapsed, a first or earliest subframe for which another MPDCCH or PDSCH for the HARQ process can be received by the WD is a bandwidth reduced low complexity coverage enhancement downlink, BL/CE DL, subframe.

21.-26. (canceled)
